(19) United States
(12) Patent Application Publication
(10) Pub. No.: US 2022/0106497 A1
(43) Pub. Date: Apr. 7, 2022

(54) RADICAL CURABLE ANTI-FOG COATINGS

(71) Applicant: SDC Technologies, Inc., Irvine, CA (US)

(72) Inventors: David Hess, Mission Viejo, CA (US); Kiranmayi Deshpande, Irvine, CA (US); Andreas Schneider, Fullerton, CA (US); Ren-Zhi Jin, Irvine, CA (US)

(21) Appl. No.: 17/492,755

(22) Filed: Oct. 4, 2021

Related U.S. Application Data
(60) Provisional application No. 63/087,724, filed on Oct. 5, 2020.

(51) Int. Cl. C09D 175/08; C08G 18/75; C08G 18/48; C08G 18/08; C08G 18/44; C08G 18/32; C08G 18/65; C08G 18/40; C08J 7/046; C09D 5/00

(52) U.S. Cl. CPC C09D 175/08; C08J 2469/00; C08G 18/4841; C08G 18/0852; C08G 18/44; C08G 18/4825; C08G 18/3206; C08G 18/6517; C08G 18/4018; C08G 18/4808; C08J 7/046; C09D 5/00; C08G 2290/00; C08J 2375/08; C08G 18/755

(57) ABSTRACT

The present disclosure provides a coating composition comprising an initiator, a radical curable polyurethane having ethylenically unsaturated functional groups, and a liquid phase, wherein the radical curable polyurethane having ethylenically unsaturated functional groups comprises the reaction products of A) a polyol component; B) a polyisocyanate component; C) an isocyanate-reactive surfactant; and D) isocyanate-reactive component having ethylenically unsaturated functional groups. The resulting cured polyurethane coating resists surface damage by fine particles and has at least washable anti-fog properties, if not permanent anti-fog properties. Articles prepared with a coating according to this invention are also disclosed.

### RELATED APPLICATIONS

This application claims priority to U.S. Provisional Application No. 63/087,724, filed on Oct. 5, 2020, the entire disclosure of which is incorporated herein by reference.

### FIELD

The present disclosure relates to coating compositions that form coatings that offer resistance to fog as well as resistance to surface damage or wear by fine particle abrasion. The present disclosure also relates to processes for making the anti-fog coating compositions, processes for coating substrates with the anti-fog coating compositions, and articles coated with such anti-fog coating compositions.

### BACKGROUND

Permanent anti-fog properties are desired in several applications such as ophthalmic and sun lenses; safety, military and sports eyewear and accessories; glazing for automotive, transportation, building and construction, greenhouses; industrial, point-of-sale and electronics displays; commercial refrigerators and freezer doors; mirrors; solar panels, and others.

Fogging occurs when the water vapor from surrounding air condenses on an article forming small water droplets. This happens when the article is at a lower temperature than that of the environment. Current anti-fog coatings usually form smooth surfaces that are hydrophilic in nature. Surfactants are used in the coating formulation to increase the surface energy of the cured coatings enabling the droplet to sheet instead of forming spherical droplets on the substrate. The resulting water sheeting effect minimizes the scattering of light thereby improving visibility.

In order to have long-lasting, or permanent, anti-fog performance, anti-fog coatings are typically formulated with large amounts of surfactants that can considerably lower the hardness of the coatings. However, oftentimes, the anti-fog coatings lose the anti-fog functionalities rather quickly and need to be rejuvenated with additional surfactants. Moreover, the long-lasting anti-fog coatings available on the market today are principally thermally cured and thus require long cure times at elevated temperatures that can impact manufacturing cost and productivity of anti-fog article manufacturers. Additionally, many of these coatings do not have abrasion resistant properties. Accordingly, there is a need for new fast-curing anti-fog coatings with long-lasting anti-fog properties without the need for rejuvenation, and better abrasion resistant properties.

Resistance to fogging and resistance to surface damage by fine particles are essential criteria for eye wear to be considered as personal protection equipment. Furthermore, personal protective eyewear is ideally required to pass European Standard EN 166 (e.g., EN 166, rev. 2001) to obtain certification. EN 166 includes several tests for different safety requirements namely, stability to elevated temperatures, resistance to ultraviolet radiation, corrosion, ignition, fogging, surface damage by large particles/fine particles etc. Test methods included in EN 166 certification are EN 167, which includes optical test methods and EN 168, which includes non-optical test methods. Resistance to fogging of the oculars (referred to as “N-mark”) and resistance to surface damage by fine particles (referred to as “K-mark”) are included in EN 168. Thus, the eye wear with cured coatings that offer resistance to fog and pass tests specified in EN 168 are considered to have EN 166 N-mark. Similarly, the eye wear with cured coatings which pass EN 168 tests for resistance to surface damage by fine particles are considered to have EN 166 K-mark.

### SUMMARY

Free radical polymerization is commonly used for rapid polymerization and curing of coatings. Both thermal and radiation-induced free radical polymerization are prevalent methods. The present anti-fog and wear resistant coating compositions of the present disclosure may be produced using either thermal or/and radiation-induced radical polymerization. In particular, aspects of the present disclosure provide fast-curing coating composition formulations with permanent and/or water-washable anti-fog properties and resistance to surface damage by fine particles.

The coating composition comprises a mixture comprising an initiator, a radical curable polyurethane having ethylenically unsaturated functional groups, and a liquid phase. The polyurethane having ethylenically unsaturated functional groups comprises the reaction products of A) a polyol component; B) a polyisocyanate component; C) an isocyanate-reactive surfactant; and D) isocyanate-reactive component having ethylenically unsaturated functional groups.

In aspects of the present disclosure, the compositions cure upon exposure to UV (Ultra Violet) radiation to provide a substrate, such as eyewear, with wear resistance properties and water-washable and/or permanent anti-fog properties. In aspects of the present disclosure, the compositions can cure upon exposure to thermal radiation, to provide a substrate, such as eyewear, with water-washable and/or permanent anti-fog properties. In aspects of the present disclosure, the compositions can cure upon exposure to UV and thermal radiation to provide a substrate, such as eyewear, with wear resistance properties and water-washable and/or permanent anti-fog properties. Water-washable and/or permanent anti-fog properties are obtained through chemical bonding of the reactive surfactant within the polymeric network of cured polyurethane. Water-washable and/or permanent anti-fog properties are also achieved by using minimal loading of the surfactant.

In aspects of the present disclosure, the compositions include a photoinitiator to initiate the radical cure of the composition. In aspects of the present disclosure, the compositions include a thermal radical initiator to initiate the thermal radical cure of the composition. In aspects of the present disclosure, the compositions include a photoinitiator and a thermal radical initiator to initiate the radical cure of the composition. In aspects of the present disclosure, the compositions do not include an initiator and use electron beam radiation to initiate the radical cure of the composition.

### DETAILED DESCRIPTION

Unless otherwise indicated herein, the phrase “permanent anti-fog properties” refer to anti-fog properties that do not dissipate or leach away over time.

Unless otherwise indicated herein, the phrase “water-washable anti-fog properties” refer to anti-fog properties that pass the N-mark test described herein.

Unless otherwise indicated herein, the phrase “wear-resistant” or “wear-resistance” refers to coatings that are resistant to surface damage by fine particles and pass the “K-mark” test.

The present disclosure provides an anti-fog coating composition with permanent and/or water-washable anti-fog properties and wear-resistance to surface damage by fine particles. The coating composition comprises a mixture comprising an initiator, a radical curable polyurethane having ethylenically unsaturated functional groups, and a liquid phase. The polyurethane having ethylenically unsaturated functional groups comprises the reaction products of A) a polyol component; B) a polyisocyanate component; C) an isocyanate-reactive surfactant; and D) an isocyanate-reactive component having ethylenically unsaturated functional groups. Aspects of the present disclosure yield anti-fog coatings with at least EN-166 N mark (anti-fog) and K mark (wear resistance) performance.

The present disclosure further provides processes for making the coating compositions and methods of use of such compositions. Free radical polymerization is commonly used for rapid polymerization and curing of coatings. Both thermal and radiation-induced free radical polymerization are prevalent methods. The present anti-fog and wear resistant coating compositions of the present disclosure may be produced using either thermal or/and radiation-induced radical polymerization. Upon cure, a hydrophilic polymeric polyurethane network is formed from the coating compositions with the reactive surfactant bound to the network due to the binding between the reactive groups of the polymer resins (e.g., polyol, polyisocyanate, and isocyanate-reactive component having ethylenically unsaturated functional groups) and reactive surfactants. The bonding of the reactive surfactant to the polyurethane polymer network provide long lasting anti-fog properties to the present coating composition when applied to a substrate and cured. The coating compositions of the present disclosure yield anti-fog coatings with both EN-166 N and K mark performance, if not anti-fog and/or wear resistance performance superior to N-mark and/or K-mark. In accordance with some aspects of the present disclosure, the coating compositions result in coatings with permanent anti-fog properties and/or water-washable anti-fog properties. In further aspects, coating compositions retain their anti-fog properties after being subjected to multiple washes, for example, at least 20 washes, according to various wash anti-fog tests described below.

In accordance with aspects of the present disclosure, the coating compositions include a hydrophilic alkoxylated acrylate as all or part of the isocyanate-reactive component having ethylenically unsaturated functional groups. This acrylate, upon cure, further contributes to the hydrophilicity, and thus the permanent anti-fog properties of the polyurethane polymeric network forming the coating, while providing the crosslinkable acrylate functionality (i.e., ethylenically unsaturated functional group) reaction sites.

Optionally, the coating compositions of the present disclosure may further include metal oxide nanoparticles that can impart further abrasion-resistant properties to the coating, upon cure, while still retaining optical transparency and/or fog resistant properties.

The present disclosure also provides articles coated with a coating formed from the coating compositions of the present disclosure. The coatings are optically transparent and are applied on optically transparent substrates, such as lenses for eyeglasses. In accordance with aspects of the present disclosure, the instant coatings may be used in cold applications, such as in ski goggles or an anti-fog freezer film or coating on transparent surfaces of a freezer or refrigerator.

### Liquid Phase

As discussed above, the coating compositions of the present disclosure comprises an initiator, a radical curable polyurethane having ethylenically unsaturated functional groups, and a liquid phase. Suitable liquid phases include water, organic solvents, and combinations thereof.

The selection of suitable organic solvents used as the liquid phase of the coating compositions described herein is dependent upon the selection of constituent components reacted to form the polyurethane, including those solvents able to dissolve the selected polyols and solvents that do not readily react with the polyisocyanates. Examples of suitable organic solvents useful for such reactions include ketones such as methylethylketone, methylisobutyl ketone, diacetone alcohol, 3,3-dimethyl-2-butanone, and pentanedione; N-methyl pyrrolidone; acetonitrile; esters; glycol esters; and tertiary alcohols such as tertiary-butyl alcohol and tertiary-amyl alcohol.

### Initiator

As discussed above, in some aspects, the coating compositions of the present disclosure comprise an initiator. Suitable initiators for use with the compositions of the present disclosure include, but are not limited to, any suitable thermal radical initiator and/or photoinitiator that initiate radiation curing of the polyurethane acrylate of the coating composition. In other words, the initiator initiates and advances the crosslinking of the curable resins, i.e., curing of the coating composition when the coating composition is exposed to radiation. Thus, in accordance with the present disclosure, the coating compositions comprise a thermal radical initiator, a photoinitiator, or a combination of a thermal radical initiator and a photoinitiator.

The thermal radical initiator initiates curing when exposed to thermal radiation, including but not limited to heat. The thermal initiator is not particularly limited, and includes an azo initiator, a peroxide initiator, a persulfate initiator, a redox initiator, and combinations thereof.

Examples of suitable azo initiators include, but are not limited to, 2,2′-azobis(4-methoxy-2,4-dimethylvaleronitrile) (VAZO 33), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64), 2,2′-azobis-2-methylbutyronitrile (VAZO 67), 1,1-azobis(l-cyclohexanecarbonitrile) (VAZO 88) (all available from DuPont Chemical), 2,2′-azobis(2-cyclopropylpropionitrile), and 2,2′-azobis(methylisobutyrate) (V-601) (available from Wako Pure Chemical Industries, Ltd), and the like.

Examples of suitable peroxide initiators include, but are not limited to, benzoyl peroxide, acetyl peroxide, lauroyl peroxide, decanoyl peroxide, dicetyl peroxydicarbonate, di(4-t-butylcyclohexyl) peroxydicarbonate (Perkadox 16S) (available from Akzo Nobel), di(2-ethylhexyl) peroxydicarbonate, t-butyl peroxypivalate (Lupersol 11) (available from Elf Atochem), t-butyl peroxy-2-ethyl hexanoate (Trigonox 21-C50) (available from Akzo Nobel), dicumyl peroxide, and the like.

Examples of suitable persulfate initiators include, but are not limited to, potassium persulfate, sodium persulfate, and ammonium persulfate.

Examples of suitable redox (oxidation and reduction) initiators include, but are not limited to, a combination of the persulfate initiator and a reducing agent such as sodium metabisulfite and sodium bisulfite; a combination of an organic peroxide and a tertiary amine-based system, such as a system based on benzoyl peroxide and dimethylaniline; and a system based on an organic hydroperoxide and a transition metal, such as a system based on cumene hydroperoxide and cobalt naphthate.

Examples of other thermal radical initiators include, but are not limited to, pinacols such as tetraphenyl 1,1,2,2-ethanediol, and the like.

The thermal radical initiator preferably comprises an azo initiator or a peroxide initiator. Further preferred are 2,2′-azobis(methylisobutyrate), benzoyl peroxide, dicumyl peroxide, t-butyl peroxypivalate and di(4-t-butylcyclohexyl) peroxydicarbonate, and a mixture of these.

The photoinitiator initiates curing of the compositions upon exposure to radiation or light. Suitable photoinitiators may be selected to react when exposed to UV light or visible light such as blue light photoinitiators.

Examples of suitable UV radiation sensitive photoinitiators or blends of initiators used in coating compositions disclosed herein include, but are not limited to, benzoin; substituted benzoins such as butyl isomers of benzoin ethers; benzophenone; substituted benzophenones such as hydroxy benzophenone; 2-hydroxyethyl-N-maleimide; 2-[2-hydroxyethyl(methyl)amino]ethanol anthraquinone; thioxanthone; α,α-diethoxyacetophenone; 2,2-dimethoxy-1,2-diphenylethan-1-one; 2-hydroxy-2-methyl-1-phenyl-propan-1-one; diphenyl(2,4,6-trimethylbenzoyl)phosphine oxide, phenyl glyoxylic acid methyl ester; 1-hydroxylcyclohexyl phenyl ketone; 2-benzyl-2-dimethylamino-1-(4-morpholinophenyl)-butanone-1; 2-dimethylamino-2-(4-methyl-benzyl)-1-(4-morpholin-4-yl-phenyl)-butan-1-one; 2-methyl-1-[4-(methylthio)phenyl]-2-morpholinopropan-1-one; and 1-[4-(2-hydroxyethoxy)-phenyl]-2-hydroxy-2-methyl-1-propane-1-one. Cationic photoacid generators may include but are not limited to diphenyl[3-(phenylsulfanyl)phenyl]sulfonium hexafluorophosphate; diphenyl[2-phenylsulfanyl)phenyl]sulfonium hexafluoroantimonate; mixtures of triarylsulfonium with hexafluoroantimonate of hexafluorophosphate salts in propylene carbonate; and diaryl iodonium salts with pentafluoroborate, hexafluoroantimonate or hexafluorophosphate.

Optionally, photoinitiator synergists are employed as coinitiators in conjunction with acyl ketone photoinitiators such as for example benzophenone. Suitable photoinitiator synergists include, for example, N-methyl-diethanol amine, triethanolamine 2-(butoxy)ethyl-4-dimethylaminobenzoate and reactive amine acrylates commercially available as EBECRYL P104, EBECRYL P105, and EBECRYL 7100 from UCB Radcure Chemicals Corporation, Smyrna, Ga. or CN 371, CN 373, CN 384, or CN 386 available commercially from Sartomer Company, Inc., Exton, Pa. Sartomer describes CN 373 as a reactive amine acrylate coinitiator that can be used in combination with a hydrogen abstracting photoinitiator, such as benzophenone or isopropyl thioxanthone (ITX), to promote free radical polymerization. CN 373 accelerates surface cure speed and helps overcome oxygen inhibition in UV curable coatings and inks. Sartomer describes CN 371, CN 384, CN 386, CN 550, and CN551 as di- and tri-functional amine acrylate coinitiators which, when used in conjunction with a photosensitizer, such as benzophenone, promote rapid curing under UV light.

As discussed above, suitable photoinitiators include a visible light photoinitiator to initiate curing of the composition upon exposure to blue light (400-500 nm). Such photoinitiators may include, but are not limited to, camphorquinone, phenylpropanedione (PPD), bisacrylphosphine oxide (IRGACURE 819), include 2,4,6-trimethylbenzoyldiphenylphosphine oxide (TPO), 2,4,6-trimethylbenzoylethoxy-phenylphosphine oxide (TPO-L), and bis(2,4,6-trimethylbenzoyl)phenylphosphine oxide (BAPO).

In some embodiments, the photoinitiator is selected from a family of alpha hydroxyl ketone photoinitiators. In some embodiments, the photoinitiators comprises one or more of IRGACURE 500 (50% Benzophenone+50% 1-hydroxy-cyclohexyl-phenyl ketone) and Darocure 1173 (2-hydroxy-2-methyl-propiophenone).

The coating compositions may be alternatively cured using electron beam (EB) radiation with minimal to no use of initiators. Accordingly, in some aspects of the present disclosure the coating compositions do not include an initiator.

The coating compositions of the present disclosure comprise one or more initiator in amounts ranging from 0.3-6 wt %, based on the total weight solids of the coating composition, including 0.4-5.9 wt %, 0.8-5.8 wt %, 09.-5.7 wt %, 1-5.5 wt %, 1.5-5 wt %, 2-4.75 wt %, and 2.5-4.5 wt %, based on the total weight solids of the coating composition.

### Radical Curable Polyurethane

As discussed above, the coating compositions of the present disclosure comprises a radical curable polyurethane. This polyurethane is radically curable because it has ethylenically unsaturated functional groups. Unless otherwise indicated herein, ethylenically unsaturated functional groups may refer to a functional group formed from a compound that can be represented by the following formula

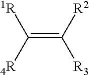

where R1, R2, R3, and R4 are independently selected from H, hydrocarbyl, or substituted hydrocarbyl groups.

The radical curable polyurethane having ethylenically unsaturated functional groups of the present disclosure is the reaction product of (A) a polyol, (B) a polyisocyanate, (C) an isocyanate-reactive surfactant, and (D) an isocyanate-reactive component having ethylenically unsaturated functional groups.

In accordance with the coating compositions of the present disclosure, any isocyanate-reactive compound having unsaturated reactive functionality can be substituted for component (D), the isocyanate-reactive component having ethylenically unsaturated functional groups. Suitable isocyanate-reactive compounds having unsaturated reactive functionality include isocyanate reactive alkenyl compounds, such as isocyanate-reactive compounds having an ethylenically unsaturated reactive group, including but not limited to reactive vinyl groups, reactive acrylate groups, reactive methacrylate groups, reactive allyl groups, and the like.

The coating compositions of the present disclosure comprise at least one radical curable polyurethane having ethylenically unsaturated functional groups in amounts ranging from 85-97.5 wt %, based on the total weight solids of the coating composition, including 87-96 wt %, 88-95.5 wt %, and 87-95 wt %, based on the total weight solids of the coating composition.

(A) Polyols

Polyols used in accordance with coating compositions of the present disclosure include at least one polyol comprising (a) a diol having main chain segments selected from the group consisting of polyethylene oxide, polypropylene oxide, and combinations thereof, and/or (b) a triol having main chain segments selected from the group consisting of polyethylene oxide, polypropylene oxide, and combinations thereof. Examples of such polyols suitable for use to form the radical curable polyurethane include a diol having polyethylene oxide side chain segments; an alkyl diol; an alkyl triol, a polycarbonate diol; a polycarbonate triol; or combinations thereof. Suitable diols having main chain segments selected from the group consisting of polyethylene oxide, polypropylene oxide, and combinations thereof used in accordance with the coating compositions disclosed herein include those described in U.S. Pat. No. 8,642,180 (the entire contents of which are incorporated by reference herein), preferably a polypropylene oxide and polyethylene oxide block copolymer diol comprising polyethylene oxide in the main chain in an amount ranging from about 10% to about 25% by weight of the polyol, including 10% to 25%, 14% to 22%, and 17% to 19% by weight of the polyol. Suitable triols having main chain segments selected from the group consisting of polyethylene oxide, polypropylene oxide, and combinations thereof used in accordance with the coating compositions disclosed herein include those described in U.S. Pat. No. 8,642,180, preferably a polypropylene oxide and polyethylene oxide copolymer triol comprising from about 60% to about 95% polyethylene oxide by weight of the polyol, including 60% to 95%, 65% to 90%, 70% to 85%, and 75% to 80% polyethylene oxide by weight of the polyol.

In accordance with aspects of the present disclosure, such polyols have one or more hydrophilic regions or domains due to the presence of one or more groups of the following formula: —((CH₂)ₙO—)ₘ. In some embodiments, n can be equal or greater than 1 and equal or less than 3 (1≤n≤3), m can be equal or greater than 1 and equal or less than 10 (1≤m≤10), or both. In some embodiment, n may be equal to 2. Suitable polyols include polyethylene oxide, ethylene glycol, propylene glycol, polypropylene oxide and mixtures thereof. Specific examples of commercially available suitable polyols include, but are not limited to POLY-G 83-34, PLURONICS, and POLAXIMERS. The polyols may additionally further comprise other polyols in addition to polyols (a) and/or (b) described above. Examples of such optional additional polyols include, but are not limited to polycarbonate polyols, polyether polyols, and polyester polyols, including polycarbonate diols or triols, polyether diols or triols, and polyester diols or triols.

The coating compositions of the present disclosure comprise one or more polyol in amounts ranging from 10-60 wt %, based on the total weight solids of the radical curable polyurethane, including 10.5-59 wt %, 11-58.5 wt %, 12-58 wt %, 15-55 wt %, 10-20 wt %, 20-50 wt %, 25-48 wt % and 35-45 wt % based on the total weight solids of the radical curable polyurethane.

(B) Polyisocyanates

Polyisocyanates used in accordance with coating compositions of the present disclosure include compounds having more than one isocyanate functionality (i.e., multifunctional isocyanates). Examples of such compounds include, but are not limited to, diisocyanates, triisocyanates, derivatives of diisocyanates and triisocyanates capable of forming polyurethane linkages, and combinations thereof. Diisocyanates are isocyanates with an isocyanate functionality of two. Examples of diisocyanates include isophorone diisocyanate hexamethylene diisocyanate (HDI), xylene diisocyanate (XDI), toluene diisocyanate (TDI), diphenylmethane diisocyanate any diisocyanates derived from the foregoing, and combinations thereof. Triisocyanates are isocyanates with an isocyanate functionality of three. Triisocyanates include derivatives of diisocyanates, such as an HDI biuret. Because of their better light stability than the aromatic poly isocyanates, aliphatic polyisocyanates, including but not limited to aliphatic diisocyanates or aliphatic triisocyanates, are preferred for the polyurethane coating compositions described herein. IPDI-type and HDI-type diisocyanates are aliphatic isocyanates. Specific examples of commercially avail able polyisocyanates include Desmophen I, Desmophen N75, and Desmophen W.

The coating compositions of the present disclosure comprise one or more polyisocyanates in amounts ranging from 5-60 wt %, based on the total weight solids of the radical curable polyurethane, including 8-58 wt %, 15-55 wt %, 5-20 wt %, 20-50 wt %, 25-45 wt % and 35-40 wt % based on the total weight solids of the radical curable polyurethane.

(C) Isocyanate-Reactive Surfactant

The reactive surfactants used in accordance with the present disclosure comprise hydrophilic regions and reactive functionality (moieties) or groups capable of reacting with the reactive groups of the resins that react to form the radical curable polyurethane of the present disclosure. Such reactive moieties include, but are not limited to, one or more of a hydroxyl group, a thiol group, an amine group, or combination thereof. Other representative reactive surfactants with an isocyanate reactive group include compounds having a general chemical formula of: B-R, where B represents a hydroxyl, a thiol, an amine, or combination thereof and where R can be selected from quaternary ammonias, ether sulfonates, phosphoric acid esters, polyethers and copolymers thereof, nonionic polyethers, alkyl ethers, alkenyl ethers, and olefinic ethers. Specific examples of commercially available isocyanate-reactive surfactants include, but are not limited to IGEPAL CO-720, CIRRASOL G-265, TERGITOL15-S-7, TEGOMER D-3403.

The coating compositions of the present disclosure comprise one or more isocyanate-reactive surfactant in amounts ranging from 1-50 wt %, based on the total weight solids of the radical curable polyurethane, including 1.5-48 wt %, 1.75-45 wt %, 1.5-20 wt %, 1.5-10 wt %, 1.75-10 wt %, 1.5-5 wt %, 1.75-5 wt %, 1.5-4.5 wt %, 1.75-4.5 wt %, 1.5-3.5 wt %, 1.75-3.5 wt %, 1.5-3.0 wt %, 1.75-3.0 wt %, 8-45 wt %, 10-40 wt %, 12-45 wt %, 15-35 wt % and 11-16 wt % based on the total weight solids of the radical curable polyurethane.

(D) Isocyanate-Reactive Component having Reactive Ethylenically Unsaturated Functionality

Suitable isocyanate-reactive component having ethylenically unsaturated functional groups can be represented by the following formula, Y—R—X, where Y is the ethylenically unsaturated functional groups, where R may be selected from polyethers, polyalkanes, polyalkenes, polyesters, or other chain extending group, and X may be selected from hydroxyl, amine, thiols, or other isocyanate reactive group. Nonlimiting examples of suitable isocyanate-reactive surfactants having ethylenically unsaturated functional groups include, but are not limited to, acrylates, preferably hydrophilic acrylates such as alkoxylated acrylates, glycidyl acrylates and the like.

Such hydrophilic acrylates have one or more hydrophilic regions or domains due to the presence of one or more groups of the following formula: —((CH₂)ₙO—)ₘ, where, n can be equal or greater than 1 and equal or less than 10 (1≤n≤10), m can be equal or greater than 1 and equal or less than 10 (1≤m≤10), or both. In aspects of the present disclosure, n may be equal to 2. In aspects of the present disclosure, m may be equal to 5. In aspects of the present disclosure, one or more alkoxylated acrylates may be employed to form the network. Specific examples of such alkoxylated acrylates include 4-hydroxybutyl acrylate, hydroxy ethyl methacrylate, hydroxy ethyl methacrylate, 2-hydroxy propyl acrylate, hydroxypropyl methacrylate, and glycerol monomethacrylate.

The ethylenically unsaturated functional groups of the isocyanate-reactive compounds having ethylenically unsaturated functional groups suitable for use with the instant compositions may be a reactive group that can react with a reactive group of the additional reactive surfactant, described below. For example, such reactive group can comprise the acrylate group.

The coating compositions of the present disclosure comprise one or more isocyanate-reactive compounds having ethylenically unsaturated functional groups in amounts ranging from 1-25 wt %, based on the total weight solids of the radical curable polyurethane, including 1.5-20 wt %, 1.5-10 wt %, 1.75-10 wt %, 1.5-5 wt %, 1.75-5 wt %, 1.5-3 wt %, 1.75-3 wt %, 3-20 wt %, 6-18 wt %, 6.5-15 wt %, and 7-12.5 wt % based on the total weight solids of the radical curable polyurethane.

(E) Optional Radical Reactive Surfactants

As described above, the reactive surfactants of the present compositions comprise hydrophilic regions and also include reactive functional groups capable of reacting with the reactive groups of the resins (e.g., isocyanates) that react to form the radical curable polyurethane of the present disclosure. Optionally, the coating compositions of the present disclosure may contain radical reactive surfactants having reactive functional groups including, but are not limited to, one or more of an alkenyl group, an acrylate group, a thiol group, or combination thereof. Accordingly, the radical reactive surfactant as disclosed herein comprise hydrophilic regions and also include reactive functionality (moieties) or groups capable of reacting one or more of an alkenyl group, an acrylate group, a thiol group or combination thereof. It should be noted that the radical reactive surfactant may be allowed to react with one or more reactive moieties either prior to adding the product of the reaction to the acrylate mix, or the radical reactive surfactant and the reactive moiety can be added to the acrylate mix at the same time.

A representative radical reactive surfactant having an alkenyl reactive group may have a general chemical formula of: (CH₂═CH)—R, where R can be selected from ether sulfonates, phosphoric acid esters, polyethers and copolymers thereof, nonionic polyethers, alkyl ethers, alkenyl ethers, and olefinic ethers, as shown in Table 1. Specific examples of commercially available radical reactive surfactants having hydrophilic segments with reactive double bond include, but are not limited to, REASOAP SR10, REASOAP SR20, REASOAP ER10, REASOAP PP70, EMULSOGEN APS100. Additional non-limiting examples of reactive surfactant with an alkenyl reactive group are presented in Table 1 below.

TABLE 1

| Compound | Description |
|---|---|
| 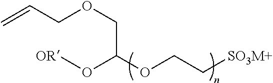 | Ether sulfonates (R′ can be alkyl, aryl, or other) n = 10, 11, ... M+ = metal or ammonium counterion |
| 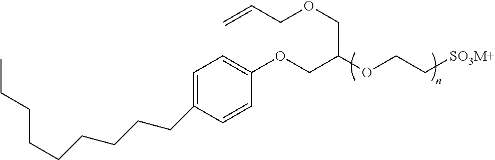 | |
| 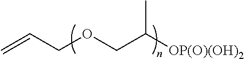 | Phosphoric acid ester n = 10, 11, ... |
| 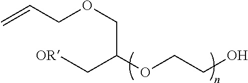 | Nonionic polyether surfactant (R′ can be alkyl, aryl or other) n = 10, 11, ... |
| 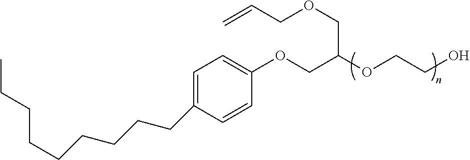 | |
| 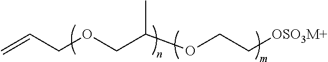 | Polyether sulfates n = 4, 5, ... m = 10, 11, ... M+ = metal or ammonium counterion |
| 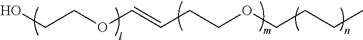 | Polyether copolymer l = 1, 2, ... n = 1, 2, ... |
| | m = 1, 2, ... |
| | p = 1, 2, ... |
| 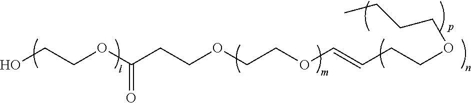 | |

A representative radical reactive surfactant with an acrylate reactive group may have a general chemical formula of: (CH₂═CHCOO)—R, where R can be selected from ether sulfonates, phosphoric acid esters, polyethers and copolymers thereof, as shown in Table 2. Illustrative examples of surfactants having hydrophilic segments with reactive acrylate moiety include, but are not limited to, metal salts of sulfopropylacrylic acid, and alkylacryloxyethyl trialkylammonium salts. Additional non-limiting examples of radical reactive surfactant with an acrylate reactive group are presented in Table 2 below.

TABLE 2

| Compound | Description |
|---|---|
| 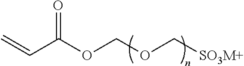 | Ether Sulfonate n = 10, 11, ... M+ = metal or ammonium counterion |
| 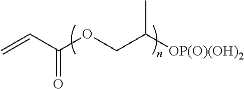 | Phosphoric acid ester n = 1, 2, ... |
| 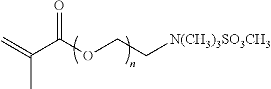 | Polyethers n = 10, 11, ... |
| 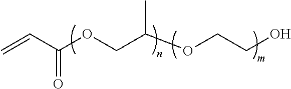 | Non-ionic Polyether Copolymers n = 1, 2, ... m = 1, 2, ... |

In some embodiments, the reactive segments of the radical reactive surfactant react with hydrophilic domains of the acrylates during the curing process. In this manner, upon curing, the radical reactive surfactant may be able to bind to the cured acrylate network and thus remain in place (not washed off or otherwise removed) to provide the coating with long-lasting anti-fog properties.

A representative radical reactive surfactant with a thiol reactive group may have a chemical formula of: (SH)—R, where R can be selected from ether sulfonates, phosphoric acid esters, polyethers and copolymers thereof, as shown in Table 3. In some embodiments, a surfactant having hydrophilic segments with reactive thiol moiety can be obtained by reacting trimethylolpropane tris (3-mercaptoproprionate) (TMPTMP) with REASOAP SR10 via thiol-ene reaction. In some embodiments, a surfactant having hydrophilic segments with reactive thiol moiety can be obtained by reacting pentaerythritol tetrakis(3-mercaptoproprionate) with REASOAP SR10 via thiol-ene reaction. Additional non-limiting examples of radical reactive surfactant with a thiol reactive are presented in Table 3 below.

TABLE 3

| Compound | Description |
|---|---|
| 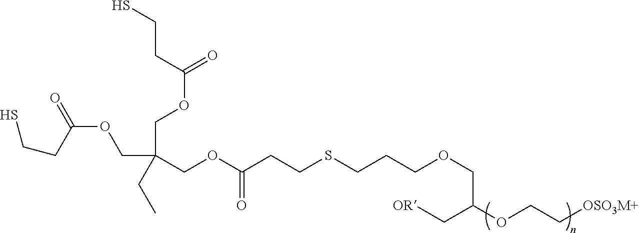 | Ether sulfonate (R′ can be alkyl, aryl, or other) n = 10, 11, ... M+ = metal or ammonium counterion |
| 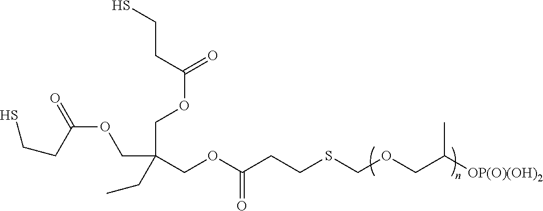 | Phosphoric acid ester n = 1, 2, ... |
| 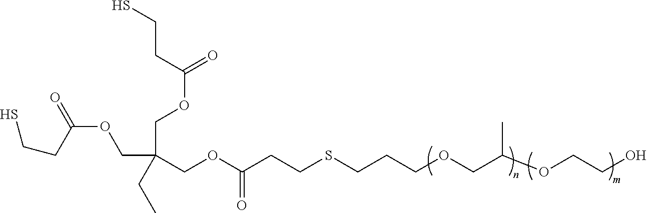 | Non-ionic Polyether Copolymers n = 1, 2, ... m = 1, 2, ... |

The coating compositions of the present disclosure comprise one or more radical reactive surfactants in amounts ranging from 0-20 wt % based on the total weight solids of the radical curable polyurethane, including 2-18 wt %, 5-15 wt %, 8-12 wt %, 9-11 wt %, 3-4 wt %, 7-8 wt %, and 16-18 wt % based on the total weight solids of the radical curable polyurethane.

(F) Optional Radical Reactive Ethylenically Unsaturated Resins

As discussed above, the coating compositions of the present disclosure comprises a radical curable polyurethane that is the reaction product of (A) a polyol, (B) a polyisocyanate, (C) an isocyanate-reactive surfactant, and (D) an isocyanate-reactive component having ethylenically unsaturated functional groups. Optionally, the coating compositions of the present disclosure may further comprise radical reactive ethylenically unsaturated resins, i.e., an ethylenically reactive compound that is not reactive with isocyanate functionality.

Preferred ethylenically unsaturated resins include those with hydrophilic properties, such as hydrophilic acrylates including but not limited to alkoxylated acrylates, glycidyl acrylates, alkoxylated vinyls, and the like. Such acrylates have one or more hydrophilic regions or domains due to the presence of one or more groups of the following formula: —((CH₂)ₙO—)ₘ, where, n can be equal or greater than 1 and equal or less than 10 (1≤n≤10), m can be equal or greater than 1 and equal or less than 10 (1≤m≤10), or both. In aspects of the present disclosure, n may be equal to 2. In aspects of the present disclosure, m may be equal to 5. In aspects of the present disclosure, one or more ethoxylated acrylates may be employed to form the network. In aspects, the acrylates include one or more acrylates with mono, di, tri, or tetrafunctional groups. In aspects, the acrylates include more than one type of acrylate monomer. In aspects, the network can be generated by use of multifunctional ethoxylated acrylate monomers. In aspects, ethoxylated diacrylates and ethoxylated triacrylates are employed to form the network.

Examples of suitable hydrophilic diacrylate monomers include, but are not limited to, ethylene glycol diacrylate; ethylene glycol dimethacrylate; diethylene glycol diacrylate; triethylene glycol diacrylate; triethylene glycol dimethacrylate; tetraethylene glycol diacrylate; tetraethylene glycol dimethacrylate; polyethylene glycol diacrylate; tripropylene glycol diacrylate; triisopropylene glycol diacrylate; polypropylene glycol dimethacrylate; polyether diacrylates derived from PLURONIC or POLAXAMER, and polyether diacrylates derived from reverse PLURONIC.

Examples of suitable hydrophilic triacrylate monomers include, but are not limited to, ethoxylated trimethylolpropane triacrylate, propoxylated glyceryl triacrylate, propoxylated trimethylolpropane triacrylate, and tris(2-hydroxyethyl) isocyanurate triacrylate.

Examples of suitable hydrophilic tetraacrylate monomers include, but are not limited to, ethoxylated pentaerythritol tetraacrylate.

The ethylenically unsaturated resins suitable for use with the instant compositions also include a reactive group that can react with a reactive group of the radical reactive surfactant, described above. For example, such reactive group can comprise the acrylate group. In some embodiments, the reactive group may be located in the hydrophilic region of the acrylates and/or in the hydrophilic region network formed upon cure of the acrylates.

(G) Optional Metal Oxide Particles

In accordance with some aspects of the present disclosure, the coating compositions may optionally further include metal oxide particles dispersed throughout the network of the radical curable polyurethane and the resins used to form the polyurethanes. The metal particles may provide hardness and abrasion resistant properties to the coatings formed from the coating compositions. Suitable examples of metal oxide nanoparticle include, but are not limited to, silica particles, titania, alumina, zinc oxides, antimony oxide, tin oxide, zirconium oxides, and combinations thereof. The size and concentration of the metal nanoparticles can be selected such that the resulting coatings are optically transparent, while still retaining their fog resistant properties and wear resistant properties. In some aspects, the metal oxide particles are nanoparticles with sizes ranging from about 5 to about 50 nm, including 5 to 50 nm, 10 to 45 nm, 15 to 40 nm, 20 to 35 nm, and 25 to 30 nm. In some aspects, the metal oxide particles are nanoparticles with sizes ranging from about 10 to about 20 nm. The nanoparticles may be present in an amount ranging from 0 and 70 wt % by weight based on the total weight solids of the radical curable polyurethane, including 5 to 60 wt %, 10 to 50 wt %, 15 to 40 wt %, and 20 to 30 wt % by weight based on the total weight solids of the radical curable polyurethane.

(H) Optional Non-Reactive Surfactants

In accordance with some aspects of the present disclosure, the coating compositions may optionally further comprise non-reactive surfactants. The non-reactive surfactants may be added to the coating composition to further enhance anti-fog property. These non-reactive surfactants can be added at any point to the coating compositions, including during and after for reaction that forms the radical curable polyurethane acrylate. Suitable non-reactive surfactants include, but are not limited to, sulfonic acid salts, ammonium salts, phosphate salts, polyethylene glycol ether oligomers, hydrophilic polyacrylates, octophenoxypolyethoxyethanols, and nonionic polyether block copolymers. In some aspects, the non-reactive surfactant may be present in an amount ranging between 0 and 15 wt % by weight based on the total weight solids of the radical curable polyurethane, including 3-12 wt %, 5-10 wt %, and 6-9 wt % by weight based on the total weight solids of the radical curable polyurethane. In some aspects, the concentration of non-reactive surfactant in the composition may range between 0.5 and 6 wt % based on the total weight solids of the radical curable polyurethane, including 0.5-5 wt %, 0.5-4 wt %, 1-3 wt %, and 1.5-2.5 wt % based on the total weight solids of the radical curable polyurethane.

(I) Optional Flow Modifiers/Leveling Agents

In accordance with some aspects of the present disclosure, the coating compositions disclosed herein may optionally further include a leveling agent. The leveling agent, which may also be known as a flow-control agent, may be incorporated into the coating compositions described herein to spread the composition more evenly or level on the surface of the substrate and to provide substantially uniform contact with the substrate. The amount of the leveling agent can vary widely but preferably is used in an amount ranging from about 0 to about 10 wt % based on weight solids of the coating composition, including 0-10 wt %, 2-8 wt %, and 4-6 wt % based on weight solids of the coating composition. Any conventional, commercially available leveling agent which is compatible with the coating composition and the substrate, which is capable of leveling the coating composition on a substrate, and which enhances wetting between the coating composition and the substrate may be employed. Non-limiting examples of such leveling agents include polyethers, silicones, fluorosurfactants, polyacrylates, silicone polyacrylates such as silicone hexaacrylate, and fluoro-modified polyacrylates. Examples include BYK 350, BYK 354, BYK 356, CAPSTONE FS-35, CAPSTONE FS-31, CAPSTONE FS-61, TRITON X-100, X-405, and N-57 from Rohm and Haas, silicones such as Paint Additive 3, Paint Additive 29, and Paint Additive 57 from Dow Corning, SILWET L-77 and SILWET L-7600 from Momentive (Columbus, Ohio), and fluorosurfactants such as FLUORAD FC-4430 from 3M Corporation (St. Paul, Minn.).

(J) Other Optional Additives

Other additives such as an antioxidant, antistatic agent, polymeric additive (e.g. polyvinylpyrrolidone), weather resistive agent, tint additive, UV stabilizer, dispersing agent, defoamer, heat stabilizer, may also be added to the coating formulation. Examples of antioxidants include octadecyl-3-(3,5-di-tertbutyl-4-hydroxyphenyl) propionate, and pentaerythrityltetrakis[3-(3,5-di-tert-butyl-4-hydroxyphenyl)propionate].

Examples of heat stabilizers include triphenyl phosphite, tris-(2,6dimethylphenyl)phosphite, tris-(2,4-di-t-butyl-phenyl)phosphite, tris-(mixed mono-and di-nonylphenyl)phosphite, dimethylbenzene phosphonate and trimethyl phosphate. Examples of the antistatic agent include glycerolmonostearate, sodium stearyl sulfonate, and sodium dodecylbenzenesulfonate.

Polycarbonates (PC) are known to degrade under the exposure of ultraviolet (UV) light. This process is known as weathering. A weatherable material can maintain its physical properties for a prolonged time under the UV exposure. In order to improve service life under UV exposure, a UV absorber may be needed in the coating for polycarbonate and similar aromatic plastic substrates. UV absorbers include, but are not limited to, three groups of chemicals: 1) 2-hydroxy-benzophenones (BP) derivatives, commercial examples include, but are not limited to, CHIMASSORB 81 and CHIMASSORB 90 (both from BASF, Germany); 2) 2-(2-hydroxyphenyl)-benzotriazole (HPBT) derivatives, commercial examples include, but are not limited to, TINUVIN 1130, TINUVIN 384-2, TINUVIN 928 and TINUVIN 900 (all from BASF, Germany); 3) 2-hydroxyphenyl-s-triazines (HPT) derivatives, commercial examples include, but are not limited to, TINUVIN 400, TINUVIN 405 (both from BASF, Germany).

Hindered amine light stabilizers (HALS) are also used for effective stabilization against the detrimental effects of light and weathering. The most widely used hindered amine light stabilizers (HALS) are mainly derivatives of 2,2,6,6-tetramethyl piperidine. Commercial examples include, but are not limited to, TINUVIN 152, TINUVIN 292 (both from BASF, Germany).

Those of ordinary skill in this field would know how much or how to determine how much of the various additives is necessary to achieve the desired result in the coating composition or the coating formed from the coating composition. Generally, no more than about 10 wt %, based on the total weight solids of the coating composition, of total additives are added to the coating compositions of the present disclosure, including no more than 10 wt %, no more than 7 wt %, no more than 4 wt %, no more than 1 wt %, and 0 wt % based on the total weight solids of the coating composition.

### Substrates/Articles

The coating compositions disclosed herein can be applied as a coating to rigid or flexible substrates. Suitable substrate materials include, but are not limited to, transparent plastics such as polycarbonate (PC), polarized polycarbonate, polyamide, polyacrylic, polymethylmethacrylate (PMMA), polyvinylchloride, polybisallyl carbonate, allyl diglycol carbonate (ADC) polymer, polyethylene terephthalate (PET), polyethylene naphthenate, cellulose triacetate (CTA) polymer, cellulose acetate butyrate (CAB) polymer, polyurethane, polyepisulfide, and polythiourethane. Other substrates including various polyolefins, fluorinated polymers, metals and glass, such as soda-lime glass, borosilicate glass, acrylic glass among other types of glass, can be used with appropriate pretreatments, if necessary. Examples of articles that may be coated with coatings of the present disclosure include, but are not limited to, safety eyewear, optical lenses, goggles, face shields, face plates for helmets, glazing used as windows in buildings, and glazing used as windshields or windows in automobiles, buses, trains, airplanes, and other transportation vehicles, multifunctional LED, LCD displays, bathroom mirrors, shower mirrors and fixtures. Coating may also be applied to commercial freezer doors, ice cream freezer doors and deli cases. In some embodiments, to increase adhesion of the present composition to the substrates, the substrates may be subjected to surface treatments and/or coated with primers. In some embodiments, acrylate-based primers may be used, particularly with PMMA substrates.

Additionally, the coated articles prepared by coating the disclosed compositions on thin flexible substrates like PC or PET film can further be mounted/applied to the articles that require anti-fog functionality for example safety eyewear, optical lenses, goggles, face shields, face plates for helmets, glazing used as windows in buildings, and glazing used as windshields or windows in automotives, buses, trains, airplanes, and other transportation vehicles, multifunctional LED, LCD displays, bathroom and shower mirrors. The coatings of the present disclosure can be cast as films, which can also be applied via a repositionable optically transparent adhesive, such as a pressure sensitive adhesive, to commercial freezer doors, ice cream freezer doors and displays, deli cases to prevent frost formation and fogging.

The coating compositions described herein can be applied in any suitable manner to a substrate. For example, the compositions of the present disclosure can be applied to solid substrates by conventional methods, such as flow coating, spray coating, curtain coating, dip coating, spin coating, slot-die coating, roll coating, and the like to form a continuous surface film on the substrate. The coating compositions are then cured by exposing the coated substrate to UV radiation provided by UV lamps, visible light radiation provided by visible light lamps or, in some embodiments, EB radiation provided by EB accelerators, or a combination of these, all of these techniques being known to those skilled in the art. Additionally, the coated articles prepared by coating the disclosed compositions on thin flexible substrates like PC or PET film can be installed or retrofitted via dry or wet lamination on rigid substrates.

In accordance with the present disclosure, a method of providing an article with anti-fog properties comprises applying to the surface the coating compositions of the present disclosure and curing the coating composition on the surface. The curing includes exposing the coating composition applied to the substrate to heat or thermal radiation, light radiation, and/or electron beam radiation. The heat or thermal radiation to the applied coating is 50 to 150° C. for 1 minute to 4 hours, preferably from 100 to 125° C. for 2 minutes to 1 hour. If the heat or thermal cure is used in combination with another radical cure mechanism such as the UV cure, the heat or thermal radiation to the applied coating is 50 to 150° C. for 1 minute to 60 minutes.

UV Cure Units that can be used for UV exposure include a Fusion Conveyor Unit or a Vela 3D UV Cure Unit. A Fusion Conveyor Units are available from Heraeus Noblelight America, Gaithersburg, Md. A Vela 3D UV Cure Unit is available from Vela Technologies, Inc. San Diego, Calif.

The cumulative UV radiation exposure needed for curing is between 1.5 to 3.0 J/cm² when using a Fusion H bulb for an exposure bulb for one minute. Using visible light generated by an LED light source of XY UV-2 UV-LED curing system available from Shenzhen Height-LED Opto-electronics Technology Co., Ltd, Shenzhen, China, with peak emission wavelength of 460±20 nm and intensity of from 200 to 300 mW/cm² at a distance of 1 to 20 cm from the LED light source, the coating compositions of the present disclosure can be cured in 1 to 30 min. In accordance with aspects of the present disclosure, the coating compositions form coatings having permanent anti-fog properties. In accordance with aspects of the present disclosure, the coating compositions form coatings water-washable anti-fog properties. In accordance with aspects of the present disclosure, the coating compositions form wear-resistant coatings, or in other words, coatings that are resistant to surface damage by fine particles. In accordance with aspects of the present disclosure, the coating compositions form coatings having permanent anti-fog, water-washable anti-fog, and wear resistant properties.

### EXAMPLES

The following examples are merely representative and should not be used to limit the scope of the present disclosure. A large variety of alternative designs exists for the methods and compositions disclosed in the examples. The selected examples are therefore used mostly to demonstrate the principles of the devices and methods disclosed herein.

### Description of Tests:

Film Thickness: Film thickness of cured coating was measured with a Filmetrics F20-CP Spectrophotometer at wavelength of 632.8 nanometers (nm) based on spectral reflectance methodology.

Haze: Light transmission and light-scattering properties of the cured coating was evaluated by measuring haze according to ASTM D 1003 standard with a Haze-gard Plus (BYK-Gardner, Columbia, Md.) hazemeter.

Adhesion: Adhesion is the ability of a coating to adhere to a substrate. The initial adhesion was tested using a roll of pressure sensitive tape 3M Brand SCOTCH 600 tape, Adhesion is also tested with Nichiban #405 tape. The test was carried out as follows: 1) a cross-hatch of a 5×5 grid, approximately 2 mm apart was made with a retractable razor blade into the cured coating; 2) the tape was pressed down firmly (using a tongue depressor) over the cross-hatched area; 3) after 90±30 s, tape was pulled at an angle of 180° or as close to substrate as possible; 4) a check for the removal of the coating was made by examination of the coated substrate using appropriate visual control; 5) the subject area was also inspected under a microscope; 6) the actual count of unaffected areas was reported as percent adhesion (when adhesion was affected along a line only, the estimate is converted into percentages).

K-mark (Abrasion Resistance to Fine Particles): The abrasion resistance to fine particles was tested according to the EN166/EN168 protocol. An anti-fog article is loaded on a rotating holder in a Cadex Falling Sand tester. 3 kg of sand is loaded into a funnel that is 6 feet above the surface of the rotating article. After the full 3 kg of sand impinges the rotating articles surface, the article is removed and washed with soap and water. After washing, the article is blown dry with filtered compressed air. The sample is then loaded into a Cadex Light Diffusion measurement device. The light diffusion must be less than 5 cd/m²*lx to pass this test.

### Anti-Fog Properties

Initial Anti-fog Test: Initial anti-fog test was carried out by positioning a coated substrate at a standard height (1″) above a beaker containing a source of 60° C. water. The coated substrate was exposed to water vapor from the 60° C. water for 1 minute. If fog appeared on the coated substrate during this test, the time taken for the appearance of the fog was recorded. If no fog appeared during 1 minute of exposure, then the coating was considered to “pass” the initial anti-fog test.

Water Soak Anti-fog Test: A coated substrate was soaked in water at room temperature for 1 hour. The coated specimen was then removed from the water, suspended on a rack at 25° C., 50% RH for 12 hours and tested for anti-fog property by placing the coated substrate above beaker containing water at 50° C. for 3 minutes. If fog appeared on the coated substrate during this test, the time taken for the appearance of the fog was recorded. If no fog appeared during 1 minute of exposure, then the coating was considered to “pass” the 1 h water soak anti-fog test.

N-mark: In addition the anti-fog property of 12 h conditioned water-soaked coated specimens was tested using a YT-810 Resistance to Fogging Tester (manufactured by Yin-Tsung Co., Ltd) according to the EN166/EN168 protocol. This procedure constitutes the N-mark test. The test involves placing the coated substrate onto the tester. When the test is started, the coated substrate is exposed to 50° C. steam, and a laser is passed through the lens. The amount of fogging was determined by reduction in the transmission of the laser light over 8 seconds (s) of exposure. The coating fails the fog test if the laser transmission falls below 80% of the initial reading during the 8 s period, if not, it is rated as a pass.

The following is a description of the substrates referred to in the application: PC Lens: Polycarbonate Ophthalmic Lens; CR-39: CR-39 Polybisallyl Carbonate Ophthalmic Lens; MR-7: MR-7 Polythiourethane Ophthalmic Lens; PC Plaque: Bayer MAKROLON Polycarbonate Sheet.

The current invention consists of the synthetic product of isocyanate-reactive surfactants, hydrophilic polyols and isophorone diisocyanate. Specifically, the following examples illustrate practical formulations of the invention. The following table includes descriptions of the chemicals referred to in the examples:

| Common Name | Chemical | Manufacturer | Product Purpose |
|---|---|---|---|
| TRIMET | trimethylol ethane | Geo Specialty Chemicals, | Polyol |
| | | Inc | |
| | | Allentown, PA | |
| Ethylene glycol | Ethylene glycol | Sigma-Aldrich | Polyol |
| | | St. Louis, MO | |
| POLY-G 83-34 | Trifunctional Polyethylene | Monument Chemical | Polyol |
| | oxide-co-polypropylene | Indianapolis, IN | |
| | oxide | | |
| ETERNACOLL | Polycarbonate diol | UBE America, Inc | Polyol |
| UH200 | | New York, NY | |
| TEGOMER D3403 | Ethoxylated polyether | Evonik Corporation | Polyol |
| | | Hopewell, VA | |
| PEG Mw300 | Polyethylene glycol | Sigma-Aldrich | Polyol |
| | polymer | St. Louis, MO | |
| DAA | Diacetone alcohol | Univar | Solvent |
| | | Downers Grove, IL | |
| PM Glycol Ether | 2-methoxy propanol | Univar | Solvent |
| | | Downers Grove, IL | |
| FOMREZ UL-22 | Dimethyltin mercaptide | Galata Chemicals | Catalyst |
| | | Southbury, CT | |
| Aerosol OT-75 | Sulfosuccinate surfactant | Cytec Industries, Inc | Surfactant |
| | | Woodland Park, NJ | |
| SCHERCOQUAT | Quaternary Amine | Lubrizol | Surfactant |
| IAS-PG | Surfactant | Brecksville, OH | |
| CIRRASOL G-265 | Fatty amine quaternary | Croda Coatings and | Reactive Surfactant |
| | ammonium salt | Polymers | |
| | | Edison, NJ | |
| TERGITOL 15-s-7 | Secondary alcohol | Sigma-Aldrich | Reactive Surfactant |
| | ethoxylate | St. Louis, MO | |
| SURFCON 94 | Proprietary Surfactant | FSI Coatings Technology | Reactive Surfactant |
| | Mix | Irvine, CA | mix |
| CAPSTONE FS-35 | Nonionic fluorosurfactant | Chemours | Surfactant |
| | | Newark, DE | |
| BYK 356 | Polyacrylate-based | BYK USA, Inc | Surfactant |
| | surfactant additive | Wallingford, CT | |
| K60 | Polyvinylpyrrolidone | Ashland | Additive |
| | polymer | Columbus, OH | |
| SOKALAN K-17 | Polyvinylpyrrolidone | BASF | Additive |
| | polymer | Florham Park, NJ | |
| PGM-AC-2140Y | Acrylate-functionalized | Nissan Chemical America | Additive |
| | Organosilicate sol | Corporations | |
| | | Houston, TX | |
| IPDI | Isophorone diisocyanate | Covestro LLC | Polyisocyanate |
| | | Pittsburgh, PA | |
| IRGACURE 1173 | 2-hydroxy-2-methyl-propiophenone | BASF | Photoinitiator |
| | | Florham Park, NJ | |
| IRGACURE 184 | Hydroxyketone | BASF | Photoinitiator |
| | | Florham Park, NJ | |
| AIBN | Azobisisobutyronitrile | Sigma-Aldrich | Thermal radical |
| | | Oakville, ON | initiator |
| VAM-110 | Oil-soluble azo | Wako Chemicals USA Inc | Thermal radical |
| | polymerization initiator | Richmond, VA | initiator |
| VA-086 | Water-soluble azo itiator | Wako Chemicals USA Inc | Thermal radical |
| | | Richmond, VA | initiator |
| 3-EGA | 3-ethylene glycol | Arkema | Ethylenically |
| | diacrylate | King of Prussia, PA | unsaturated |
| | | | crosslinker |
| 4-HBA | 4-hydroxybutylacrylate | San Estes Corporation | Isocyanate-reactive |
| | | New York, NY | ethylenically |
| | | | unsaturated |
| | | | component |
| | | | crosslinker |

### Example 1

19.74 g of trimethylolethane, 9.87 g of ethylene glycol, 78.97 g of POLY-G 83-34, and 276.41 g of DAA were loaded into a round-bottom flask and mixed at 50° C. until dissolved. 195.85 g isophorone diisocyanate, 9.87 g of ETERNACOLL UH200, and 63.18 g of TEGOMER D3403 were added to the flask. 0.18 g of FOMREZ UL-22 was then added to the flask and mixed at 70° C. for 30 minutes. 188.35 g DAA, 15.07 g Aerosol OT-75, 6.46 g SCHERCOQUAT IAS-PG, 59.23 g CIRRASOL G-265, 1.97 g TERGITOL15-s-7, and 0.18 g FOMREZ UL-22 were added to the round bottom flask and allowed to mix at 70° C. for 1 hour. After mixing, 63.18 g 4-hydroxybutyl acrylate and 0.18 g FOMREZ UL-22 were added to the mixture and allowed to mix for 30 minutes at 70° C.

11.85 g trimethylolethane and 0.18 g UL-22 were added to the round bottom flask and mixed for 2 hours at 70° C. After mixing the flask was cooled to room temperature.

After the mixture is cooled, 726 g 1-methoxy propanol and 18.73 g of IRGACURE 1173 were added and mixed at room temperature for 1 hour. The sample was dipcoated onto a polycarbonate lens and cured using a Vela 3D (UV) cure unit at 2.0 J/cm². Cured coating properties are shown in Table 4.

### Example 2

25.00 g of trimethylolethane, 10.00 g of ethylene glycol, 100.00 g of POLY-G 83-34, and 276.41 g of DAA were loaded into a round-bottom flask and mixed at 50° C. until dissolved. 215.00 g isophorone diisocyanate, 10.00 g of ETERNACOLL UH200, and 60.00 g of TEGOMER D3403 were added to the flask. 0.18 g of FOMREZ UL-22 was then added to the flask and mixed at 70° C. for 30 minutes.

125.00 g SURFCON 94 and 0.18 g FOMREZ UL-22 were added to the round bottom flask and allowed to mix at 70° C. for 1 hour. After mixing, 75.00 g 4-hydroxybutyl acrylate and 0.18 g FOMREZ UL-22 were added to the mixture and allowed to mix for 30 minutes at 70° C.

15.00 g trimethylolethane and 0.18 g UL-22 were added to the round bottom flask and mixed for 2 hours at 70° C. After mixing the flask was cooled to room temperature.

After the mixture is cooled, 725 g 1-methoxy propanol and 20.22 g of IRGACURE 1173 were added and mixed at room temperature for 1 hour. The sample was dipcoated onto a polycarbonate lens and cured using a Vela 3D (UV) cure unit at 2.0 J/cm². Cured coating properties are shown in Table 4.

### Example 3

7.79 g of trimethylolethane, 4.54 g of ethylene glycol, 37.63 g of POLY-G 83-34, and 181.68 g of DAA were loaded into a round-bottom flask and mixed at 50° C. until dissolved. 77.86 g isophorone diisocyanate, 6.49 g of ETERNACOLL UH200, and 31.14 g of TEGOMER D3403 were added to the flask. 0.08 g of FOMREZ UL-22 was then added to the flask and mixed at 70° C. for 30 minutes.

90.84 g DAA, 7.26 g Aerosol OT-75, 3.11 g SCHERCOQUAT IAS-PG, 28.55 CIRRASOL G-265, 1.04 g TERGITOL15-s-7, and 0.18 g FOMREZ UL-22 were added to the round bottom flask and allowed to mix at 70° C. for 1 hour. After mixing, 16.87 g 4-hydroxybutyl acrylate and 0.08 g FOMREZ UL-22 were added to the mixture and allowed to mix for 30 minutes at 70° C.

5.19 g trimethylolethane and 0.08 g UL-22 were added to the round bottom flask and mixed for 2 hours at 70° C. After mixing the flask was cooled to room temperature.

After the mixture is cooled, 363 g 1-methoxy propanol and 9.37 g of IRGACURE 1173 were added and mixed at room temperature for 1 hour. The sample was dipcoated onto a polycarbonate lens and cured using a Vela 3D (UV) cure unit at 2.0 J/cm². Cured coating properties are shown in Table 4.

### Example 4 (Comparative)

1.78 g of trimethylolethane, 1.75 g of ethylene glycol, 41.26 g of POLY-G 83-34, and 79.10 g of DAA were loaded into a round-bottom flask and mixed at 50° C. until dissolved. 19.70 g of isophorone diisocyanate, 6.22 g of ETERNACOLL UH200, 16.44 g of CIRRASOL G-265, and 10.38 g of PEG Mw300 were added to the flask. 0.08 g of FOMREZ UL-22 was then added to the flask and mixed at 70° C. for 30 minutes.

16.50 g IPDI, 15.20 g 4-hydroxybutylacrylate, and 0.08 g FOMREZ UL-22 were added to the round bottom flask and allowed to mix at 70° C. for 1 hour.

After the mixture is cooled, 114.40 g of 1-methoxy propanol and 3.87 g of IRGACURE 1173 were added and mixed at room temperature for 1 hour. The sample was dipcoated onto a polycarbonate lens and cured using a Vela 3D (UV) cure unit at 2.0 J/cm². Cured coating properties are shown in Table 4.

### Example 5

100 g of Example 1 was mixed with 0.4 g of 3-EGA for 1 hour at room temperature conditions. The sample was dipcoated onto a polycarbonate lens and cured using a Vela 3D (UV) cure unit at 2.0 J/cm². Cured coating properties are shown in Table 4.

### Example 6

100 g of Example 3 was mixed with 0.4 g of 3-EGA for 1 hour at room temperature conditions. The sample was dipcoated onto a polycarbonate lens and cured using a Vela 3D (UV) cure unit at 2.0 J/cm². Cured coating properties are shown in Table 4.

### Example 7

100 g of Example 1 was mixed with 0.2 g of 3-EGA for 1 hour at room temperature conditions. The sample was dipcoated onto a polycarbonate lens and cured using a Vela 3D (UV) cure unit at 2.0 J/cm². Cured coating properties are shown in Table 4.

### Example 8

100 g of Example 3 was mixed with 0.2 g of 3-EGA for 1 hour at room temperature conditions. The sample was dipcoated onto a polycarbonate lens and cured using a Vela 3D (UV) cure unit at 2.0 J/cm². Cured coating properties are shown in Table 4.

TABLE 4
Cured coating properties of Examples 1-8.

| | | | | | | | K-Mark |
|---|---|---|---|---|---|---|---|
| | | | | | | | (Resistance |
| | | | Adhesion | Initial | Water Soak | | to Damage |
| | | | (%) (Scotch | Anti-fog | Anti-fog | | by fine |
| | Thickness | Haze | 3M 600, | (60° C., | Test (50° C., | N-Mark | particles, |
| | (um) | (%) | 3 pulls) | 3 min) | 3 min) | (anti-fog) | En166) |
| Example 1 | 8.0 | 0.15 | 100% | Pass | Pass | Pass | Pass |
| Example 2 | 8.7 | 0.17 | 100% | Pass | Pass | Pass | Pass |
| Example 3 | 7.5 | 0.35 | 100% | Pass | Pass | Pass | Fail |
| Example 4 | 8.0 | 0.20 | 100% | Pass | Fail | Fail | Fail |
| Example 5 | 8.8 | 0.16 | 100% | Pass | Pass | Pass | Pass |
| Example 6 | 8.7 | 0.14 | 100% | Pass | Pass | Pass | Pass |
| Example 7 | 8.1 | 0.18 | 100% | Pass | Pass | Pass | Pass |
| Example 8 | 8.8 | 0.17 | 100% | Pass | Pass | Pass | Pass |

### Example 9

19.74 g of trimethylolethane, 9.87 g of ethylene glycol, 78.97 g of POLY-G 83-34, and 276.41 g of DAA were loaded into a round-bottom flask and mixed at 50° C. until dissolved. 195.85 g of isophorone diisocyanate, 9.87 g of ETERNACOLL UH200, and 63.18 g of TEGOMER D3403 were added to the flask. 0.18 g of FOMREZ UL-22 was then added to the flask and mixed at 70° C. for 30 minutes.

152.0 SURFCON 94 and 0.18 g FOMREZ UL-22 were added to the round bottom flask and allowed to mix at 70° C. for 1 hour. After mixing, 63.18 g 4-hydroxybutyl acrylate and 0.18 g FOMREZ UL-22 were added to the mixture and allowed to mix for 30 minutes at 70° C.

11.85 g trimethylolethane and 0.18 g UL-22 were added to the round bottom flask and mixed for 2 hours at 70° C. After mixing the flask was cooled to room temperature.

### Example 10

To 7.00 g of the Example 9, 1.75 g of PGM-AC-2140Y was added while stirring. After mixing for 15 minutes, 3.00 g of PM glycol ether was added while stirring. This was followed by addition of 0.05 g thermal radical initiator (AIBN). 0.10 g of 10% BYK 356 in PM, and 0.04 g of mixture of CAPSTONE FS35 and SCHERCOQUAT IAS-PG in the ratio 1:25, were added. The coating solution was mixed for 30 min.

Coated parts were prepared by flow coating the liquid formulations on polycarbonate substrate. All the parts were air dried for 1 min. Thermal curing was then initiated at 90° C. for 3 min and completed at 90° C. for 4 hrs. Coated properties are listed in Table 5.

### Example 11

To 7.00 g of the Example 9, 1.75 g of PGM-AC-2140Y was added while stirring. After mixing for 15 minutes, 3.00 g of PM glycol ether was added while stirring. This was followed by addition of 0.05 g thermal radical initiator (VAM-110). 0.10 g of 10% BYK 356 in PM, and 0.04 g of mixture of CAPSTONE FS35 and SCHERCOQUAT IAS-PG in the ratio 1:25, were added. The coating solution was mixed for 30 min.

Coated parts were prepared by flow coating the liquid formulations on polycarbonate substrate. All the parts were air dried for 1 min. Thermal curing was then initiated at 90° C. for 3 min and completed at 115° C. for 2 h. Coated properties are listed in Table 5.

### Example 11A

Another set of coated parts using the same liquid formulation of Example 11 were prepared by flow coating on polycarbonate substrates. Parts were air dried for 1 min. Thermal curing was then initiated at 90° C. for 3 min and completed at 110° C. for 45 min. Coated properties are listed in Table 5.

### Example 12

To 7.00 g of the Example 9, 1.75 g of PGM-AC-2140Y was added while stirring. After mixing for 15 minutes, 3.00 g of PM glycol ether was added while stirring. This was followed by addition of 0.05 g thermal radical initiator (VA-086). 0.10 g of 10% BYK 356 in PM, and 0.04 g of mixture of CAPSTONE FS35 and SCHERCOQUAT IAS-PG in the ratio 1:25, were added. The coating solution was mixed for 30 min.

Coated parts were prepared by flow coating the liquid formulations on polycarbonate substrate. All the parts were air dried for 1 min. Thermal curing was then initiated at 90° C. for 3 min and completed at 100° C. for 4 h. Coated properties are listed in Table 5.

### Example 13

To 50.00 g of Example 9, 0.74 g of IRGACURE 184 and 30.00 g of a 10% mix of SOKALAN K17 in PM were added. The mixture was agitated for at least 20 minutes prior to coating.

Coated parts were prepared by flow coating the liquid formulations on polycarbonate substrate. All the parts were air dried for 1 min. and initially thermally cured at 90° C. for 3 min. The cure was completed using a Vela 3D (UV) Cure Unit at 2.0 J/cm². Coated properties are listed in Table 6.

### Example 14

To 50.00 g of Example 9, 0.74 g of IRGACURE 184 and 10.00 g of a 30% K60 in water were added. After mixing for 2 minutes, 20.00 g of PM was added to the beaker. The mixture was agitated for at least 20 minutes prior to coating.

Coated parts were prepared by flow coating the liquid formulations on polycarbonate substrate. All the parts were air dried for 1 min, and initially thermally cured at 90° C. for 3 min. The cure was completed using a Vela 3D (UV) cure unit at 2.0 J/cm². Coated properties are listed in Table 6.

TABLE 5
Comparison of Coating Performance of Thermal
Cure Samples of Examples 10-12

| | | | Adhesion | Initial | Water Soak | |
|---|---|---|---|---|---|---|
| | | | (Scotch | Anti-fog | Anti-fog | |
| | Thickness | Haze | 3M 600, | (60° C., | Test (50° C., | N-Mark |
| | (um) | (%) | 3 pulls) | 3 min) | 3 min) | (anti-fog) |
| Example 10 | 7.3 | 0.40 | Pass | Pass | Pass | Pass |
| Example 11 | 8.8 | 0.35 | Pass | Pass | Pass | Pass |
| Example 11A | 8.6 | 0.4 | Pass | Pass | Pass | Pass |
| Example 12 | 9.5 | 0.30 | Pass | Pass | Pass | Pass |

TABLE 6
Comparison of Coating Performance of Examples 13 and 14

| | | | Adhesion | Initial | Water Soak | |
|---|---|---|---|---|---|---|
| | | | (Scotch | Anti-fog | Anti-fog | |
| | Thickness | Haze | 3M 600, | (60° C., | Test (50° C., | N-Mark |
| | (um) | (%) | 3 pulls) | 3 min) | 3 min) | (anti-fog) |
| Example 13 | 6.0-8.0 | 0.44 | Pass | Pass | Pass | Pass |
| Example 14 | 2.0-4.0 | >1.0 | Pass | Pass | Pass | Pass |

### Example 15 (Comparative)

In accordance with JP H11-140109, a prepolymer was synthesized in the laboratory (Synthesis II, Table 9). The formulations were mixed overnight (15a, 15b, 15c, Table 10). These formulations were then applied to a polycarbonate substrate and cured with a Fusion Conveyor (UV) cure unit. The coatings did not pass K-mark or N-mark. Table 11 shows the comparative example performance summary for these coating formulations.

TABLE 9
Synthesis II products

| | | | | |
|---|---|---|---|---|
| 1 | Anhydrous Citric acid | 34.6 | g | Mix at |
| 2 | Polyethyleneglycol diglycidyl ether (200) | 207.6 | g | 90° C. |
| 3 | Dimethylamine Hydrochloride | 3 | g | for 3 h |
| 4 | Acrylic acid | 57.9 | g | |
| 5 | Hydroquinone | 0.3 | g | |

TABLE 10
Comparative Example Formulations

| | Example 15a | | Example 15b | | Example 15c | |
|---|---|---|---|---|---|---|
| Synthesis II | 60 | g | 45 | g | 40 | g |
| M-220 Tri Propylene | 30 | g | 0 | g | 0 | g |
| glycol diacrylate | | | | | | |
| M-240 Tetraethylene | 0 | g | 45 | g | 40 | g |
| glycol diacrylate | | | | | | |
| Adeka ER-10 | 10 | g | 10 | g | 20 | g |
| IRGACURE 184 | 3 | g | 3 | g | 3 | g |

TABLE 11
Comparative Example Performance Summary

| | Example 15a | Example 15b | Example 15c |
|---|---|---|---|
| Thickness (um) | Cannot Measure | 8.0-15.0 | 8.0-15.0 |
| Haze (%) | 16.0 | 0.84 | 1.26 |
| Initial AF | Fog free for | Fog free for | Fog free for |
| (60° C., 3 min) | less than 30 s | less than 30 s | less than 30 s |
| | Fail | Fail | Fail |
| Water-Soak | Fail | Fail | Fail |
| Anti-Fog Test | | | |
| K-mark | Fail | Fail | Fail |

### Example 16 (Comparative)

Following U.S. Pat. No. 8,642,180, Example 5 was synthesized in the lab as a comparative example. The coating liquid was applied to polycarbonate substrates via dipcoating and exposed to UV radiation in a Vela 3D cure unit at 2.0 J/cm². The coating liquid remained tacky to the touch and did not cure under UV radiation.

### Example 17 (Comparative)

U.S. Pat. No. 10,221,331 outlines a UV curable formulation that offers washable anti-fog with high steel wool abrasion resistance but not resistance to surface damage by fine particles (EN166 K Mark). The coating compositions of the present disclosure are directed to specially engineered urethane acrylate, which is thermally curable and/or UV curable, with exceptional anti-fog property passing EN166 N mark and resistance to surface damage by fine particles passing EN166 K Mark.

### Example 18

100 g of Example 2 was mixed with 0.25 g of azobisisobutyronitrile (AIBN) overnight at room temperature conditions. The sample was dipcoated onto a polycarbonate lens. Samples were initially cured at 90° C. for at least 5 minutes and cure was completed using a Vela 3D (UV) cure unit at 2.0 J/cm². Cured coating properties are shown in Table 7.

### Example 19

100 g of Example 2 was mixed with 0.38 g of AIBN overnight at room temperature conditions. The sample was dipcoated onto a polycarbonate lens. Samples were initially cured at 90° C. for at least 5 minutes and cure was completed using a Vela 3D (UV) cure unit at 2.0 J/cm². Cured coating properties are shown in Table 7.

TABLE 7
Dual Radical Cure Coating Properties

| | | | Initial | | | |
|---|---|---|---|---|---|---|
| | Thickness | Haze | Adhesion | Initial | | |
| Sample | (um) | (%) | (%) | AF | N-mark | K-mark |
| Example 18 | 9.3 | 0.47 | 100% | Pass | Pass | Pass |
| Example 19 | 9.6 | 0.39 | 100% | Pass | Pass | Pass |

### Example 20

Example 2 was dipcoated onto a polycarbonate lens and cured using a Fusion Conveyor UV cure unit at 2.0 J/cm². Cured coating properties are shown in Table 8.

TABLE 8
Fusion Conveyor Cure Unit Performance

| | Thickness | Haze | Adhesion | Initial | | |
|---|---|---|---|---|---|---|
| Sample | (mm) | (%) | (%) | AF | N-Mark | K-mark |
| Example 20 | 9.2 | 0.35 | 100% | Pass | Pass | Pass |

While the present disclosure describes exemplary aspects of coating compositions, articles, and methods in detail, the present disclosure is not intended to be limited to the disclosed aspects. Also, certain elements of exemplary aspects disclosed herein are not limited to any exemplary aspects, but instead apply to all aspects of the present disclosure.

The terminology as set forth herein is for description of the aspects of this disclosures only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, the phrase “at least one of A, B, and C” should be interpreted as “only A or only B or only C or any combinations thereof.”

The coating compositions, articles, and associate methods of making the coating composition or the article of the present disclosure can comprise, consist of, or consist essentially of the essential elements of the disclosure as described herein, as well as any additional or optional element described herein or which is otherwise useful in coating applications.

All percentages, parts, and ratios as used herein are by weight of the total composition, unless otherwise specified. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

1. A coating composition comprising a mixture of an initiator, a radical curable polyurethane having ethylenically unsaturated functional groups, and a liquid phase, wherein the radical curable polyurethane having ethylenically unsaturated functional groups comprises the reaction products of:
A. a polyol component;
B. a polyisocyanate component;
C. an isocyanate-reactive surfactant; and
D. isocyanate-reactive component having ethylenically unsaturated functional groups.

2. The coating composition of claim 1 wherein the isocyanate-reactive component having ethylenically unsaturated functional groups is present in an amount ranging from 1 wt % and 25 wt % based on the total weight solids of the radical curable polyurethane.

3. The coating composition of claim 1, wherein the isocyanate-reactive component having an ethylenically unsaturated functional groups comprises an isocyanate-reactive alkoxylated acrylate.

4. The coating composition of claim 1, wherein an isocyanate-reactive surfactant is selected from quaternary ammonias, ether sulfonates, phosphoric acid esters, polyethers, polyether copolymers, alkyl ethers, alkenyl ethers, olefinic ethers, and combinations thereof.

5. The coating composition of claim 1, wherein the isocyanate-reactive surfactant is present in amounts ranging from 1-50 wt % based on the total weight solids of the radical curable polyurethane.

6. The coating composition of claim 1, wherein the polyol comprises a diol having main chain segments selected from the group consisting of polyethylene oxide, polypropylene oxide, and combinations thereof, and/or (b) a triol having main chain segments selected from the group consisting of polyethylene oxide, polypropylene oxide, and combinations thereof.

7. The coating composition of claim 1, wherein the liquid phase comprises water, an organic solvent, or a combination thereof.

8. The coating composition of claim 3, wherein the alkoxylated acrylate comprises a hydroxyl group.

9. The composition of claim 1, further comprising a non-reactive surfactant.

10. The coating composition of claim 1, further comprising metal oxide nanoparticles.

11. The coating composition of claim 1, further comprising multifunctional alkoxylated acrylate monomers.

12. The coating composition of claim 1, further comprising a radical reactive surfactant having reactive functional groups comprising one or more of an alkenyl group, an acrylate group, a thiol group, or combination thereof.

13. An article comprising: a substrate and a transparent anti-fog coating applied onto the substrate, wherein the coating is formed from the coating composition of claim 1.

14. The coating composition of claim 1, wherein, when cured on a substrate, the coating has water-washable anti-fog properties.

15. The coating composition of claim 1, wherein, when cured on a substrate, the coating has wear-resistant properties.

16. The coating composition of claim 1, wherein, when cured on a substrate, the coating has water-washable anti-fog properties and wear-resistant properties.

17. A coating composition comprising a mixture of an electron-beam curable polyurethane having ethylenically unsaturated functional groups and a liquid phase, wherein the radical curable polyurethane having ethylenically unsaturated functional groups comprises the reaction products of:
A. a polyol component;
B. a polyisocyanate component;
C. an isocyanate-reactive surfactant; and
D. isocyanate-reactive component having ethylenically unsaturated functional groups.

18. An article comprising a substrate and the coating composition of claim 17 cured thereon.

19. The coating composition of claim 1, wherein, when cured, the coating formed from the coating composition has at least one of the EN166 K-mark, EN166 N-mark, or both the EN166 K-mark and EN166 N-mark.

20. The coating composition of claim 17, wherein, when cured, the coating formed from the coating composition has at least one of the EN166 K-mark, EN166 N-mark, or both the EN166 K-mark and EN166 N-mark.
